(19) United States
(12) Patent Application Publication
(10) Pub. No.: US 2009/0090134 A1
(43) Pub. Date: Apr. 9, 2009

(54) PRODUCTION OF SELF-SUPPORTING GLASS FILM

(75) Inventor: Toshihiro Kasai, Kanagawa pref (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 12/282,415

(22) PCT Filed: Mar. 26, 2007
(86) PCT No.: PCT/US2007/064922

§ 371 Date: Sep. 10, 2008

(30) Foreign Application Priority Data
Mar. 27, 2006 (JP) 2006-085118

(51) Int. Cl. C03C 3/089; C03B 19/12

(52) U.S. Cl. 65/17.2; 501/12

(57) ABSTRACT

A process is described for production of a self-supporting glass film that includes the steps of preparing a boron-containing aqueous solution containing boric acid and an alkanolamine; producing a mixture that includes the boron-containing aqueous solution, a colloidal silica sol and an organic binder; applying the mixture onto a base material to form a coating; drying the coating to form a precursor film on the base material; releasing the precursor film from the base material; and firing the released precursor film. A self-supporting glass film prepared using this process is also described.

### FIELD

A self-supporting glass film is described as well as a sol-gel process for the production of the self-supporting glass film.

### BACKGROUND

Normal sol-gel processes utilize a metal oxide or hydroxide sol that is obtained from an inorganic compound solution, an organic metal compound solution of a metal alkoxide, or a similar compound. The sol is then gelled, and the gel is heated to produce a ceramic or glass.

Silica (SiO₂) glass production processes using sol-gel processes are known. Numerous examples are described by S. Sakka in the book Sol Gel Science, which was published by Agune Shofu Publishing. Most sol-gel processes are for the production of films less than 1 μm (micrometer) thick and use a metal alkoxide solution for integral formation on a base such as glass or a conductor. Although bulk type SiO₂ glass formed using a sol-gel process have been prepared separately and independently of a base, special drying machines (e.g., drying machines for supercritical drying) have been used to prevent the occurrences of cracks during the drying step. If the special drying equipment is not utilized, the drying must be carried out very slowly. For example, Japanese Unexamined Patent Publication SHO No. 61-236619 describes a production process for quartz glass using a sol-gel process. The drying method involves maintaining the film overnight at 20° C. and then using a container cover with a prescribed opening ratio for drying at 60° C. for 10 days. Similarly, Japanese Unexamined Patent Publication HEI No. 4-292425 describes a production process for silica glass using a sol-gel process. The starting sol is placed in a dish, gelled at room temperature, and then the cover of the dish is replaced with one containing holes for drying at 60° C. for 100 days. Such prolonged drying is considered a major obstacle for production via these methods.

Glass production processes using a melt method are also known. These processes often use a low boiling point boron oxides or a similar material to lower the softening point of the glass. However, when boron is added to a sol-gel process, the relatively low solubility of boric acid in water often limits the amount of boron oxide that can be added.

Furthermore, bulk type SiO₂ glass produced by conventional sol-gel processes generally have a thickness of several tens of millimeters or greater. Methods for producing self-supporting glass films are therefore of interest.

### SUMMARY

A self-supporting glass film is described that contains a high boron oxide content and that has a low softening temperature. A process for production of a self-supporting glass film using a sol-gel process is also described. The sol-gel process does not require a prolonged drying step and typically results in the formation of crack-free self-supporting glass films.

The process for production of a self-supporting glass film includes the steps of preparing a boron-containing aqueous solution by combining boric acid, an alkanolamine, and water; producing a mixture comprising the boron-containing aqueous solution, a colloidal silica sol, and an organic binder; applying the mixture onto a base material to form a coating; drying the coating to form a precursor film on the base material; releasing the precursor film from the base material; and firing the released precursor film.

### DETAILED DESCRIPTION

As used herein, a “self-supporting glass film” refers to a self-supporting thin film-like glass that requires no support. The thickness of the self-supporting glass film is typically no greater than about 2 millimeters (mm). Some self-supporting films have a thickness in the range of 5 micrometers to 2 millimeters.

Self-supporting glass films produced as discussed herein can have enhanced weather resistance, heat resistance, corrosion resistance, or a combination thereof. Because the films are self-supporting, they can be more flexible than a panel and can be used for attachment to different types of substrates such as plastic films, for example.

Glass ceramic self-supporting films are produced with sol-gel processes as described herein. In such processes, first a boron-containing aqueous solution is prepared by combining boric acid, an alkanolamine, and water. A mixture is then prepared that contains the boron-containing aqueous solution, a colloidal silica sol, and an organic binder. It is thought, but not relied upon, that the alkanolamine can improve the solubility of the boric acid in water at room temperature. That is, the alkanolamine tends to increase the amount of boron-containing material that can be dissolved in water at room temperature. This can afford the addition of boron oxide to the resulting glass film in an amount that could not be achieved via the addition of boric acid alone. As a result, a glass film with a low softening point can be formed at low firing temperatures.

### Boron-Containing Aqueous Solution

A process used herein utilizes a boron-containing aqueous solution. The boron-containing aqueous solution is prepared by mixing boric acid, at least one alkanolamine, and water. Because boric acid has low solubility in water at room temperature, it can usually only be dissolved to a concentration of about 5-6% by weight. However, the concentration of boric acid in water can be increase with the addition of an alkanolamine. That is, an alkanolamine can increase the amount of boron-containing material that can be dissolved in water. A higher level of boron in the coating composition can allow a lower firing temperature in the subsequent firing step used to form the self-supporting glass film. It is thought, but not relied upon that formation of highly water-soluble complexes of alkanolamine and boric acid may afford this advantage. Furthermore, addition of an alkanolamine can inhibit cracking in the precursor film during the subsequent drying step.

Exemplary alkanolamines that may be utilized in the boron-containing aqueous solution include, but are not limited to, alkanolamine organic additives such as triethanolamine, diethanolamine, or monoethanolamine. Alkanolamine organic additives may be used alone or in combinations of two or more.

High amounts of alkanolamine in the boron-containing aqueous solution can increase the amount of boron-containing material dissolved in water. Generally the amount of alkanolamine addition may vary somewhat depending on the specific compounds utilized. In some embodiments, the alkanolamine is about 0.25 mole or greater for monoethanolamine, 0.3 mole or greater for diethanolamine, and 0.5 mole or greater for triethanolamine, all with respect to 1 mole of boric acid. The alkanolamine can generally increase the solubility of boric acid in water.

If the amount of alkanolamine organic additive is too great, drying of the coating to form the precursor film may be notably delayed. In one embodiment, the amount of alkanolamine organic additive in the mixture is not greater than about 100 wt % with respect to the weight of silica and boron oxide (SiO₂+B₂O₃) as the inorganic solid components in the mixture. In another embodiment, the amount of alkanolamine is not greater than about 80 wt % with respect to the weight of silica and boron oxide (SiO₂+B₂O₃) as the inorganic solid components in the mixture. In yet another embodiment, the amount of alkanolamine is not greater than about 50 wt % with respect to the weight of silica and boron oxide (SiO₂+B₂O₃) as the inorganic solid components in the mixture. The weight in terms of silica and boron oxide (SiO₂+B₂O₃) in the mixture corresponds to the final self-supporting glass film component weight.

If the amount of alkanolamine organic additive in the mixture is too low, cracks can tend to occur in the drying and firing steps. Generally, in one embodiment, the alkanolamine organic additive is at least about 2% as the weight percentage with respect to the weight of silica and boron oxide (SiO₂+B₂O₃) in the mixture. In another embodiment, the alkanolamine organic additive is at least about 5% as the weight percentage with respect to the weight of silica and boron oxide (SiO₂+B₂O₃) in the mixture. In yet another embodiment, the alkanolamine organic additive is at least about 8% as the weight percentage with respect to the weight of silica and boron oxide (SiO₂+B₂O₃) in the mixture.

In one embodiment, the alkanolamine organic additive is from about 2 to about 100% as the weight percentage with respect to the weight of silica and boron oxide (SiO₂+B₂O₃) in the mixture. In some embodiments, addition of an excess of alkanolamine can be utilized in order to inhibit crystallization of the boric acid. However, in order to avoid insufficient drying in the drying step or hampering the removal of the organic binder during firing, the minimum amount of alkanolamine organic additive can be utilized.

In one embodiment, the amount of boric acid added is less than about 35 wt % as the weight ratio in terms of boric oxide (B₂O₃) with respect to the weight of silica and boron oxide (SiO₂+B₂O₃) as the inorganic solid components in the mixture. Addition at greater than about 35 wt % can cause glass melting before the decomposition of the organic compounds at low temperature in the firing step after drying. This could result in a black film with abundant residual carbon. Addition of amounts less than about 35 wt % generally produces a glass film with very little or no residual carbon. In one embodiment, the boric acid is utilized at less than about 30 wt % such as in the range of 10 wt % to 25 wt %.

### Colloidal Silica Sol

Colloidal silica sols having silica fine particles dispersed stably in a dispersing medium can generally be utilized. Any kind of dispersing media typically used by one of skill in the art can be utilized herein. In some embodiments, water may be used as the dispersing medium to produce an aqueous silica sol. In other embodiments, the dispersing medium contains water and a water-miscible organic solvent.

The average particle size of the silica fine particles in the silica sol is generally not greater than about 300 nm (nanometers). In another embodiment, the average particle size of the silica fine particles in the silica sol is generally not greater than about 100 nm. In yet another embodiment, the average particle size of the silica fine particles in the silica sol is generally not greater than about 50 nm.

A sol with excessively large silica fine particles can hamper formation of a transparent film. Furthermore, excessively large particle sizes may reduce the dispersion stability and result in non-uniformity in the film. Particle sizes that are excessively large are also generally not utilized because the gaps between the particles will become so large that a higher firing temperature for densification of the film may be required. On the other hand, the average particle size is generally at least about 4 nm. In another embodiment, the average particle size is at least about 8 nm. If the particle size is too small, cracks in the film can occur more easily.

Some colloidal silica sols that are utilized include sodium. The sodium concentration of the colloidal silica sol can differ depending on the particular sol that is utilized. Without the addition of the boron-containing aqueous solution to the mixture, a high sodium concentration in the colloidal silica sol often leads to increased crystallization of the glass film and to the formation of a brittle, non-transparent glass film. However, when the colloidal silica sol is mixed with the boron-containing aqueous solution, the crystallinity of the glass can be reduced and, as a result, it is possible to obtain a strong transparent self-supporting film even with a relatively high sodium concentration (for example a NaO₂ concentration of 0.1 wt % or greater).

### Organic Binder

A mixture is prepared that contains the boron-containing aqueous solution, the colloidal silica sol and an organic binder. Generally, organic binders that can be utilized include, but are not limited to, acrylic aqueous emulsions and polyurethane aqueous emulsions. Addition of a large amount of organic binder tends to improve the strength of the precursor film (i.e. the film before firing), but can also result in significant shrinkage during the firing step. Significant shrinkage can be accompanied with the formation of cracks in the film. A large amount of organic binder can also increase the production cost.

In one embodiment, the amount of organic binder added is not greater than about 100 wt % with respect to the weight of silica and boron oxide (SiO₂+B₂O₃) as the inorganic solid components in the mixture. In another embodiment, the amount of organic binder utilized is not greater than about 80 wt % with respect to the weight of silica and boron oxide (SiO₂+B₂O₃) as the inorganic solid components in the mixture. In yet another embodiment, the amount of organic binder utilized is not greater than about 50 wt % with respect to the weight of silica and boron oxide (SiO₂+B₂O₃) as the inorganic solid components in the mixture. If too little organic binder is used, the precursor film may have insufficient strength. This can make the precursor film susceptible to tearing during the release step from the base material prior to firing. In one embodiment, the amount of organic binder utilized is about 5 wt % to about 100 wt % with respect to the weight of silica and boron oxide in the mixture.

### Optional Additives

Additives may optionally be included in the mixture comprising the colloidal silica sol, boron-containing aqueous solution, and organic binder. Exemplary organic additives are typically miscible with water. Suitable organic additives include, but are not limited to, polyhydric alcohols such as y-butyrolactone, lactic acid, ethylene glycol, glycerin and 1,4-butanediol; and polyalcohol derivatives such as ethyleneglycol monopropylether. Like the alkanolamine, such optional additives can further inhibit the occurrence of cracks while also conferring plasticity to the precursor film, resulting in improved handling properties. In embodiments where such optional additives are utilized, the amount of such optional additives is generally not greater than about 100 wt % with respect to the of silica and boron oxide in the mixture. In another embodiment where such optional additives are utilized, the amount of such optional additives is generally not greater than about 80 wt % with respect to the weight of silica and boron oxide in the mixture. In another embodiment where such optional additives are utilized, the amount of such optional additives is generally not greater than about 50 wt % with respect to the weight of silica and boron oxide in the mixture.

### Process Steps

A process for production of a self-supporting glass film as described herein includes the steps of: preparing a boron-containing aqueous solution by combining boric acid, an alkanolamine, and water; producing a mixture comprising the boron-containing aqueous solution, a colloidal silica sol and an organic binder; applying the mixture onto a base material to form a coating; drying the coating to form a precursor film on the base material; releasing the precursor film from the base material; and firing the released precursor film.

To prepare the mixture, the boron-containing aqueous solution is combined with the colloidal silica sol and organic binder. The mixture is then coated onto a base material and dried to gel the mixture. This results in the formation of a precursor film.

The base material can include any base material generally utilized by those of skill in the art. Exemplary base materials include plastic films including, but not limited to, polyester films such as polyethylene terephthalate (PET), acrylic films such as polymethyl methacrylate (PMMA), polycarbonates, and polyimides; glass; ceramic; and metal. The base material may optionally be subjected to release treatments such as silicone treatment in order to facilitate release of the film after drying. In an embodiment where a relatively thin film is to be formed, often a base material will be used without release treatment in order to avoid impairing the film-forming properties of the mixture.

The method used for coating the mixture onto the base material can include, but is not limited to, spray coating, bar coating, die coating, knife coating, casting, or printing methods such as screen printing.

In one embodiment, the coating is dried at room temperature (i.e., about 20° C. to 30° C.). In another embodiment, the coated mixture is dried by heating. The drying may be performed either at atmospheric pressure or under reduced pressure. Several hours of drying may be sufficient even if the drying is carried out at atmospheric pressure and room temperature. The drying step yields a dried coating layer, which is referred to herein as the precursor film.

After drying, the precursor film is typically released from the base material. The precursor film can be released from the base material by methods commonly utilized by those of skill in the art. The released film is then fired. In one embodiment, pre-firing steps can be carried out on the precursor film. Such pre-firing steps include, but are not limited to, cutting the precursor film to a desired size.

If the precursor film is not released before firing, the heat of the firing step can produce stress due to the difference in thermal expansion coefficients of the base material and the precursor film. This stress can create cracks. Also, when the precursor film is released before firing it is possible to select a base material without regard to its firing temperature. This allows the use of a flexible base material such as a resin film, for example, as the base material. Using a flexible base material can reduce stress on the precursor film when it is released from the base material.

An electric furnace or other similar devices known to those of skill in the art may be used for firing. In one embodiment, staged heating (i.e., multiple stages of heating) can be utilized. In an initial stage, the temperature is increased slowly at a heating rate of, for example, of about 5° C./min. In another embodiment, a heating rate of about 3° C./min can be utilized in the initial stage. In yet another embodiment, a heating rate of about 1° C./min can be utilized in the initial stage. The initial stage can continue until the organic material (e.g., organic binder and alkanolamine) reaches its burnout temperature (about 450° C. to 500° C.). The burnout temperature refers to the temperature where the organic material decomposes and/or is converted to volatile material. After the initial stage, the temperature is increased at a higher heating rate of, for example, about 5° C./min to 10° C./min, up to the final temperature. The self-supporting glass film can be formed by firing for 15 minutes or longer at the firing temperature. The firing temperature can vary depending on the amount of boric acid added, but will generally be about 700° C. to 1400° C.

In the processes that are utilized, the inclusion of an alkanolamine organic additive in the silica sol mixture allows drying of the coated solution to be carried out in a relatively short time, while also preventing cracks in the precursor film during the drying step. Moreover, since a large amount of boric acid can be added, the softening point of the glass can be effectively lowered, thereby allowing the firing temperature to be lowered. It is therefore possible to form not only thin films but also relatively thick films. The production processes, as described herein can yield films having thicknesses between about 5 μm and about 2 mm. The films are often no greater than 1.5 mm, no greater than 1.2 mm, no greater than 1.0 mm, or no greater than 0.8 mm.

Self-supporting glass films formed herein may be attached to any substrate, including, but not limited to, plastic films, metal, wood, concrete, or ceramic. Adding a glass film produced as disclosed herein can increase the heat resistance of the substrate, improve the scratch resistance of the substrate, improve the chemical resistance of the substrate, or combinations thereof. In one embodiment, gas barrier properties of the substrate can be enhanced if a densified film is produced by forming the glass film under the prescribed firing conditions. In another embodiment, heat insulating properties can be provided to the substrate if the glass film is formed without thorough densification.

In some embodiment, glass films may be used by attaching them to plastic films. Such articles can be used, for example, in display devices such as plasma display panels (PDP) or liquid crystal display panels (LCP). Additionally, such articles can be used be used as lightweight structural materials for windows and the like.

### EXAMPLES

The disclosure is described below by referring to Examples, but the disclosure is of course not limited by these Examples.

### Example 1

100 grams of boric acid (Wako Pure Chemical Industries Co., Ltd.) was added to 200 grams of water, followed by the addition of 25 grams of 2-aminoethanol (Wako Pure Chemical Industries Co., Ltd.). The solution was then mixed to prepare a boron-containing aqueous solution.

0.29 grams of the previously prepared boron-containing aqueous solution and 0.3 grams of monoethanolamine (Wako Pure Chemical Industries Co., Ltd.) were added to 4.66 grams of a colloidal silica sol Snowtex ST-O (Nissan Chemical Co., Ltd.—particle size: 10-20 nm, solid content: 20.5 wt %, NaO₂ content: 330 ppm). The ratio of boron oxide to the sum of silica and boron oxide (B₂O₃/(SiO₂+B₂O₃)) as the inorganic solid components by weight in the mixture was 5 wt %.

2.63 grams of an aqueous acrylic emulsion AE986A (JSR Corp.—solids content: 35 wt %) was added to the solution above to prepare a sol mixture (organic binder wt % with respect to weight of inorganic solid components silica and boron oxide: 48 wt %, monoethanol wt % with respect to weight of inorganic solid components silica and boron oxide: 23 wt %).

The mixture was cast onto a silicone-treated polyethylene terephthalate (PET) film (Toray Corp.—SP PET-01-25BU). The cast film was then dried at room temperature overnight to form a precursor film on the PET film. The precursor film was removed from the PET film and fired on an alumina substrate in an electric furnace by slowly raising the temperature from room temperature to 500° C. over a period of 3 hours (heating rate: 2.65° C./min) to remove the organic binder. The temperature was then raised to 1400° C. over a period of one hour (heating rate: 15° C./min) and firing was continued for 15 minutes at 1400° C. The material that was obtained was transparent. X-ray diffraction (XRD) analysis confirmed that it was amorphous (glass). The thickness of the self-supporting glass film was confirmed by caliper measurement to be 0.4 mm. The characteristics of the film are shown in Table 1.

### Example 2

A self-supporting glass film was produced similar to Example 1. However, Snowtex ST-C (Nissan Chemical Co., Ltd.—particle size: 10-20 nm, solid content: 20.5 wt %, NaO₂ content: 0.11 wt %) having a high sodium concentration was utilized as the silica sol instead of Snowtex ST-O. Firing of the film at 1250° C. yielded a transparent glass film. The thickness of the glass film was 0.5 mm. The characteristics of the film are shown in Table 1 below.

### Example 3

A self-supporting glass film was produced similar to Example 2. The organic binder utilized was an aqueous polyurethane emulsion RESAMINE D6060 KA13 (Dainichiseika Co., Ltd., solid content: 35%) instead of the acrylic emulsion AE986A used in Example 2. The glass film that was obtained was also transparent after firing at 1000° C. The thickness of this glass film was 0.4 mm. The results are shown in Table 1 below.

### Comparative Example

A self-supporting glass film similar to Example 1 was attempted to be produced using 0.09 grams of boric acid powder added directly to the colloidal silica sol instead of utilizing a boron-containing aqueous solution. That is, this sample was prepared without any alkanolamine. The obtained sol exhibited white crystals as drying progressed, and ultimately a non-uniform gel film was produced. Numerous cracks occurred upon firing the gel film. The results are shown in Table 1 below.

TABLE 1

| | | | | Boron- | | | |
|---|---|---|---|---|---|---|---|
| | | Colloidal | Colloidal | containing | | | |
| Example | B₂O₃/ | silica | silica | aqueous | Organic | Firing | |
| No. | (SiO₂ + B₂O₃) | type | weight | solution | binder type | temperature | Thickness |
| 1 | 5 wt % | ST-O | 4.66 g | 0.29 g | Aqueous | 1400° C. | 0.4 mm |
| | | | | | acrylic | | |
| | | | | | emulsion*¹ | | |
| 2 | 5 wt % | ST-C | 4.66 g | 0.29 g | Aqueous | 1250° C. | 0.5 mm |
| | | | | | acrylic | | |
| | | | | | emulsion*¹ | | |
| 3 | 5 wt % | ST-C | 4.66 g | 0.29 g | Aqueous | 1000° C. | 0.5 mm |
| | | | | | polyurethane | | |
| | | | | | emulsion*² | | |
| Comp. | 9 wt % | ST-O | 4.66 g | Boric acid | Aqueous | | |
| Ex. 1 | | | | 0.09 g | acrylic | | |
| | | | | | emulsion*¹ | | |

*¹AE986A
*²AD6060

### Examples 4-10

Self-supporting glass films were produced similar to Example 2. However, the SiO₂-B₂O₃ ratio was changed, and firing was performed at various temperatures as shown in Table 2. Table 2 also shows the approximate minimum firing temperatures and film thicknesses which produced transparent self-supporting glass films.

As shown in Table 2, the firing temperature required to obtain a transparent self-supporting glass film decreased as the boron content increased. Example 9, which had a B₂O₃ content of 40 wt %, produced a self-supporting glass film at a firing temperature of 600° C. but the film was somewhat blackened regardless of the firing temperature.

TABLE 2

| | | Colloidal | | Boron- | Firing | | |
|---|---|---|---|---|---|---|---|
| Exam- | B₂O₃/ | silica | | containing | temperature | | |
| ple | (SiO₂ + | (ST-C) | | aqueous | for transparent | | Thick- |
| # | B₂O₃) | weight | | solution | glass | | ness |
| 4 | 10 wt % | 4.39 | g | 0.58 g | 1000° | C. | 1.0 mm |
| 5 | 12 wt % | 4.29 | g | 0.69 g | 900° | C. | 1.3 mm |
| 6 | 15 wt % | 4.15 | g | 0.87 g | 900° | C. | 1.4 mm |
| 7 | 17 wt % | 4.05 | g | 0.98 g | 800° | C. | 1.2 mm |
| 8 | 20 wt % | 3.9 | g | 1.16 g | 800° | C. | 1.0 mm |
| 9 | 25 wt % | 3.66 | g | 1.45 g | 700° | C. | 1.4 mm |

| | | | | | | |
|---|---|---|---|---|---|---|
| 10 | 40 wt % | 2.93 | g | 2.31 g | — | 1.3 mm |

### Examples 11-14

Self-supporting glass films were produced similar to Example 2 with the exception that a different boric acid solution was utilized. The boric acid solution used for these examples was prepared by adding 100 grams of boric acid (Wako Pure Chemical Industries Co., Ltd.) to 200 grams of water, and then adding 53 grams of monoethanolamine (Wako Pure Chemical Industries Co., Ltd.) and mixing to obtain an aqueous solution. As shown in Table 3, the boric acid addition amounts for Examples 11-14 were 5 wt %, 10 wt %, 15 wt %, and 20 wt % respectively in terms of B₂O₃/(SiO₂+B₂O₃). The proportions, firing results and film thicknesses are shown in Table 3.

### Examples 15-18

Self-supporting glass films were produced similar to Examples 11-14 with the exception that a different base material was utilized. For these examples a non-treated polyethylene terephthalate (PET) film (LUMILAR 50T-60, Toray Corp.) was used as the base material for casting. Each precursor film was released from the PET film and then fired to obtain a glass film. The thicknesses of the glass films are shown in Table 3.

TABLE 3

| | | | | Colloidal | Boron- | | Organic | Firing | | | |
|---|---|---|---|---|---|---|---|---|---|---|---|
| | | | Cast | silica | containing | Monoetha- | binder | temperature for | | | |
| Ex. | B₂O₃/ | | Base | (ST-C) | aqueous | nolamine | (AE986A) | transparent | | | |
| No. | (SiO₂ + B₂O₃) | | Material | weight | solution | weight | weight | glass | | Thickness | |
| 11 | 5 | wt % | Silicone- | 4.66 g | 0.31 g | 0.3 g | 2.63 g | 1000° | C. | 1.0 | mm |
| | | | treated | | | | | | | | |
| | | | PET | | | | | | | | |
| 12 | 10 | wt % | Silicone- | 4.39 g | 0.63 g | 0.3 g | 2.63 g | 900° | C. | 1.2 | mm |
| | | | treated | | | | | | | | |
| | | | PET | | | | | | | | |
| 13 | 15 | wt % | Silicone- | 4.15 g | 0.94 g | 0.3 g | 2.63 g | 900° | C. | 1.3 | mm |
| | | | treated | | | | | | | | |
| | | | PET | | | | | | | | |
| 14 | 20 | wt % | Silicone- | 3.90 g | 1.26 g | 0.3 g | 2.63 g | 900° | C. | 1.1 | mm |
| | | | treated | | | | | | | | |
| | | | PET | | | | | | | | |
| 15 | 5 | wt % | Non- | 4.66 g | 0.31 g | 0.3 g | 2.63 g | 1000° | C. | 150 | μm |
| | | | treated | | | | | | | | |
| | | | PET | | | | | | | | |
| 16 | 10 | wt % | Non- | 4.39 g | 0.63 g | 0.3 g | 2.63 g | 900° | C. | 150 | μm |
| | | | treated | | | | | | | | |
| | | | PET | | | | | | | | |
| 17 | 15 | wt % | Non- | 4.15 g | 0.94 g | 0.3 g | 2.63 g | 900° | C. | 150 | μm |
| | | | treated | | | | | | | | |
| | | | PET | | | | | | | | |
| 18 | 20 | wt % | Non- | 3.90 g | 1.26 g | 0.3 g | 2.63 g | 900° | C. | 150 | μm |
| | | | treated | | | | | | | | |
| | | | PET | | | | | | | | |

### Examples 19-22

Self-supporting glass films were produced similar to Examples 11-14 with the exception that a different boron-containing aqueous solution was utilized. The boron-containing aqueous solution used for these examples was prepared by adding 100 grams of boric acid (Wako Pure Chemical Industries Co., Ltd.) to 200 grams of water, and then adding 120 grams of monoethanolamine (Wako Pure Chemical Industries Co., Ltd.) and mixing to obtain an aqueous solution. As shown in Table 4, the boric acid addition amounts in Examples 19-22 were 5 wt %, 10 wt %, 15 wt % and 20 wt % respectively in terms of B₂O₃/(SiO₂+B₂O₃). The proportions, firing results and film thicknesses are shown in Table 4.

### Examples 23-26

Self-supporting glass films were produced similar to Examples 19-22 with the exception that a different base material was utilized. For these examples a non-treated polyethylene terephthalate (PET) film (LUMILAR 50T-60, Toray Corp.) was used as the base material for casting. Each precursor film was released from the PET film and then fired to obtain a glass film. The thicknesses of the glass films are shown in Table 4.

TABLE 4

| | | | | Colloidal | Boron- | | Organic | Firing | | |
|---|---|---|---|---|---|---|---|---|---|---|
| | | | Cast | silica | containing | Monoetha- | binder | temp. for | | |
| | B₂O₃/ | | Base | (ST-C) | aqueous | nolamine | (AE986A) | transparent | | |
| Example | (SiO₂ + B₂O₃) | | Material | weight | solution | weight | weight | glass | | Thickness |
| 19 | 5 | wt % | Silicone- | 4.66 g | 0.37 g | 0.3 g | 2.63 g | 1000° | C. | 180 μm |
| | | | treated | | | | | | | |
| | | | PET | | | | | | | |
| 20 | 10 | wt % | Silicone- | 4.39 g | 0.75 g | 0.3 g | 2.63 g | 900° | C. | 200 μm |
| | | | treated | | | | | | | |
| | | | PET | | | | | | | |
| 21 | 15 | wt % | Silicone- | 4.15 g | 1.12 g | 0.3 g | 2.63 g | 900° | C. | 170 μm |
| | | | treated | | | | | | | |
| | | | PET | | | | | | | |
| 22 | 20 | wt % | Silicone- | 3.90 g | 1.50 g | 0.3 g | 2.63 g | 900° | C. | 220 μm |
| | | | treated | | | | | | | |
| | | | PET | | | | | | | |
| 23 | 5 | wt % | Non- | 4.66 g | 0.37 g | 0.3 g | 2.63 g | 1000° | C. | 180 μm |
| | | | treated | | | | | | | |
| | | | PET | | | | | | | |
| 24 | 10 | wt % | Non- | 4.39 g | 0.75 g | 0.3 g | 2.63 g | 900° | C. | 200 μm |
| | | | treated | | | | | | | |
| | | | PET | | | | | | | |
| 25 | 15 | wt % | Non- | 4.15 g | 1.12 g | 0.3 g | 2.63 g | 900° | C. | 170 μm |
| | | | treated | | | | | | | |
| | | | PET | | | | | | | |
| 26 | 20 | wt % | Non- | 3.90 g | 1.50 g | 0.3 g | 2.63 g | 900° | C. | 220 μm |
| | | | treated | | | | | | | |
| | | | PET | | | | | | | |

### Examples 27-30

Self-supporting glass films were produced similar to Examples 11-14 with the exception that diethanolamine (DEA) was used in preparing the boric acid solution instead of monoethanolamine (MEA).

The proportions and firing results are shown in Table 5.

### Example 31

A self-supporting glass film was produced similar to Examples 11-14 with the exception that triethanolamine (TEA) was used in preparing the boric acid solution instead of monoethanolamine (MEA).

The proportions and firing results are shown in Table 5.

TABLE 5

| | | | Colloidal | Boron- | Alkanol- | Organic | Firing | | |
|---|---|---|---|---|---|---|---|---|---|
| | | | silica | containing | amine | binder | temp. for | | |
| Ex. | B₂O₃/ | | (ST-C) | aqueous | type and | (AE986A) | transparent | | |
| No. | (SiO₂ + B₂O₃) | | weight | solution | amount | weight | glass | | Thickness |
| 27 | 5 | wt % | 4.66 g | 0.31 g | DEA | 2.63 g | 1000° | C. | 160 μm |
| | | | | | 0.3 g | | | | |
| 28 | 10 | wt % | 4.39 g | 0.63 g | DEA | 2.63 g | 900° | C. | 170 μm |
| | | | | | 0.3 g | | | | |
| 29 | 15 | wt % | 4.15 g | 0.94 g | DEA | 2.63 g | 900° | C. | 210 μm |
| | | | | | 0.3 g | | | | |
| 30 | 20 | wt % | 3.90 g | 1.26 g | DEA | 2.63 g | 900° | C. | 190 μm |
| | | | | | 0.3 g | | | | |
| 31 | 5 | wt % | 4.66 g | 0.31 g | TEA | 2.63 g | 1000° | C. | 180 μm |
| | | | | | 0.3 g | | | | |

### Examples 32-34

Self-supporting glass films were produced similar to Examples 11-14 with the exception that the organic binder used was an aqueous polyurethane emulsion RESAMINE D6060 KA13 (Dainichiseika Co., Ltd., solid content: 35%) instead of the acrylic emulsion AE986A. The proportions and firing results are shown in Table 6.

TABLE 6

| | | Colloidal | Boron- | Alkanol- | Organic | Firing | |
|---|---|---|---|---|---|---|---|
| | | silica | containing | amine | binder | temp. for | |
| Ex. | B₂O₃/ | (ST-C) | aqueous | type and | (AE986A) | transparent | |
| No. | (SiO₂ + B₂O₃) | weight | solution | amount | weight | glass | Thickness |
| 32 | 10 wt % | 4.39 g | 0.63 g | DEA | 2.63 g | 900° C. | 170 μm |
| | | | | 0.3 g | | | |
| 33 | 15 wt % | 4.15 g | 0.94 g | DEA | 2.63 g | 900° C. | 150 μm |
| | | | | 0.3 g | | | |
| 34 | 20 wt % | 3.90 g | 1.26 g | DEA | 2.63 g | 800° C. | 160 μm |
| | | | | 0.3 g | | | |

1. A process for producing a self-supporting glass film, the process comprising the steps of:
preparing a boron-containing aqueous solution, wherein the boron-containing aqueous solution comprises the reaction product of boric acid, at least one alkanolamine, and water;
producing a mixture comprising the boron-containing aqueous solution, a colloidal silica sol, and an organic binder;
applying the mixture onto a base material to form a coating;
drying the coating to form a precursor film on the base material;
releasing the precursor film from the base material; and
firing the released precursor film to form a self-supporting glass film.

2. A process according to claim 1, wherein the amount of boron in the mixture is less than about 35 wt %, expressed in terms of the weight percentage of B₂O₃ with respect to the weight of silica and boron oxide (SiO₂+B₂O₃) in the mixture.

3. A process according to claim 1, wherein the alkanolamine is triethanolamine, diethanolamine, monoethanolamine, or a combination thereof.

4. A process according to any one of claims 1, wherein the amount of the alkanolamine in the mixture is from about 2 to about 100 wt % with respect to the weight in terms of silica and boron oxide (SiO₂+B₂O₃) in the mixture.

5. A process according to any one of claims 1, wherein the organic binder is an aqueous acrylic emulsion, an aqueous polyurethane emulsion, or mixture thereof.

6. A process according to any one of claims 1, wherein the amount of the organic binder in the mixture is from about 5 to about 100 wt % with respect to the weight in terms of silica and boron oxide (SiO₂+B₂O₃) in the mixture.

7. A process according to any one of claims 1, wherein the colloidal silica sol has particles that have an average size that is less than or equal to about 300 nm.

8. A process according to any one of claims 1, wherein the thickness of the self-supporting glass film is from about 5 μm to about 2 mm.

9. A process according to any one of claims 1, wherein the amount of boron is less than about 10 to about 25 wt %, expressed in terms of the weight percentage of B₂O₃ with respect to the weight in terms of silica and boron oxide (SiO₂+B₂O₃) in the mixture.

10. A process according to any one of claims 1, wherein the firing step is carried out at a temperature that is not higher than 1000° C.

11. A self-supporting glass film produced according to the process of claim 1.
